(19) United States
(12) Patent Application Publication
(10) Pub. No.: US 2026/0125972 A1
(43) Pub. Date: May 7, 2026

(54) METHODS AND APPARATUSES FOR AUTOMATICALLY IMPROVING WELL MANAGEMENT IN SYSTEMS OF WELLS

(71) Applicant: ExxonMobil Technology and Engineering Company, Spring, TX (US)

(72) Inventors: Lingxiao ZHANG, Sugar Land, TX (US); Chong Hyun AHN, Houston, TX (US); Ge YUAN, Spring, TX (US); Manjunath R. NALLAPUSALA, Spring, TX (US); Amr S. EL-BAKRY, Houston, TX (US); Emmanouil KARANTINOS, Tomball, TX (US); Neal L. ADAIR, Spring, TX (US); Brock B. ARGYLE, Spring, TX (US); Varun GUPTA, Cypress, TX (US)

(21) Appl. No.: 19/372,566

(22) Filed: Oct. 29, 2025

Related U.S. Application Data
(60) Provisional application No. 63/715,992, filed on Nov. 4, 2024.

(51) Int. Cl. E21B 43/25; E21B 43/12; G06N 20/00

(52) U.S. Cl. CPC E21B 43/25; E21B 43/122; G06N 20/00; E21B 2200/20

(57) ABSTRACT

An example method includes managing a number of machine learning models. The method includes tuning the received machine learning models based on a set of metrics to produce a number of tuned machine learning models. The method includes generating an optimization recommendation in response to receiving statistical information. The method includes modifying an operation condition based on the optimization recommendation to improve oil production.

### CROSS-REFERENCE TO RELATED APPLICATION

This application claims the benefit of U.S. Provisional Application Ser. No. 63/715,992, entitled “METHODS AND APPARATUSES FOR AUTOMATICALLY IMPROVING WELL MANAGEMENT IN SYSTEMS OF WELLS,” filed Nov. 4, 2024, the disclosure of which is hereby incorporated by reference in its entirety.

### TECHNICAL FIELD

The present application relates generally to the field of hydrocarbon management. Specifically, the disclosure relates to a methodology for improving production in a system of wells.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Oil and gas (OG) production in unconventional (Uncon) OG fields has become a major component of world OG production. The production level is expected to increase in the next decade. What has qualified as unconventional at any particular time is a complex function of resource characteristics, the available exploration and production technologies, the economic environment, and the scale, frequency and duration of production from the resource. Perceptions of these factors inevitably changes over time and often differ among users of the term. As used herein, the term “unconventional resources” is used in reference to oil and gas resources whose porosity, permeability, fluid trapping mechanism, or other characteristics differ from conventional sandstone and carbonate reservoirs. For example, coalbed methane, gas hydrates, shale gas, fractured reservoirs, and tight gas sands are considered unconventional resources.

### SUMMARY

An embodiment provided herein relates to an apparatus. The apparatus includes a first sub-system to manage a number of machine learning models. The first sub-system is to accept and respond to an external query. The apparatus includes a second sub-system to receive a machine learning model from the first sub-system and to tune the machine learning model based on a set of metrics to produce a tuned machine learning model. The second sub-system is to send a model component of the tuned machine learning model to the first sub-system. The apparatus includes a third sub-system to generate an optimization recommendation in response to receiving statistical information from the first sub-system. The optimization recommendation is used to modify operation conditions to improve oil production.

Another embodiment provided herein related to a method for managing a system of wells. The method includes managing a number of machine learning models. The method also includes tuning a machine learning model of the number of machine learning models based on a set of metrics to produce a tuned machine learning model. The method further includes generating an optimization recommendation in response to receiving statistical information. The method also further includes modifying an operation condition based on the optimization recommendation to improve oil production.

These and other features and attributes of the disclosed embodiments of the present techniques and their advantageous applications and/or uses will be apparent from the detailed description that follows.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is a schematic view of an exemplary active learning framework, in accordance with the present techniques;

FIG. 2 is a block diagram of an exemplary model management system in accordance with the present techniques;

FIG. 3 is a block diagram of an exemplary model quality control system, in accordance with the present techniques;

FIG. 4 is a block diagram of an exemplary recommendation system, in accordance with the present techniques;

FIG. 5 is a process flow diagram of an exemplary method for guiding hydrocarbon production using operating conditions modified based on optimization recommendations, in accordance with the present techniques;

FIG. 6 is a block diagram of an exemplary cluster computing system that may be utilized to implement the present techniques;

FIG. 7 is a block diagram of an exemplary non-transitory, computer-readable storage medium that may be used for the storage of data and modules of program instructions for implementing the present techniques; and

FIG. 8 is a schematic view of an exemplary system for predicting changes in temperature and pressure in a system of wells using an active learning framework, in accordance with the present techniques.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “artificial lift” refers to a process intended to add energy to the hydraulic column in the well, and reduces the downhole pressure so that a reservoir with lower pressure can flow into the well. An artificial lift system is any system that adds energy to the fluid column in a wellbore with the objective of initiating and improving production from the well. Artificial lift systems may use a range of operating principles, including rod pumping, gas lift, and electric submersible pumps. Artificial lift may include two basic types: pumping and gas lift. Pumping systems can include electric submersible pumps, beam pumps, progressing cavity pumps, plunger lifts and hydraulic pumps. Gas lift systems aid flow to the surface by reducing the density of formation fluids in the wellbore. Gas lift systems include valves installed at various depths along the tubing string, which open in response to pressure exerted on them by the rising fluid column.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the term “battery” refers to installation of similar or identical units of equipment in a group, such as a separator battery, header battery, filter battery, or tank battery. The phrase “battery site” refers to a portion of land that contains separators, treaters, dehydrators, storage tanks, pumps, compressors, and other surface equipment in which fluids coming from a well are separated, measured, or stored.

As used herein, the term “choke” refers to a device incorporating an orifice that is used to control fluid flow rate or downstream system pressure. Chokes are available in several configurations for both fixed and adjustable modes of operation. Adjustable chokes enable the fluid flow and pressure parameters to be changed to suit process or production requirements.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “geophysical data” as used herein broadly includes seismic data, as well as other data obtained from non-seismic geophysical methods such as electrical resistivity. In this regard, examples of geophysical data include, but are not limited to, seismic data, gravity surveys, magnetic data, electromagnetic data, well logs, image logs, radar data, or temperature data.

Generally speaking, the term “pressure”refers to a force acting on a unit area. Pressure is typically provided in units of pounds per square inch (psi).

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, “hydrocarbon management”, “managing hydrocarbons” or “hydrocarbon resource management” includes any one, any combination, or all of the following: hydrocarbon extraction; hydrocarbon production, (e.g., drilling a well and prospecting for, and/or producing, hydrocarbons using the well; and/or, causing a well to be drilled, e.g., to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities, such activities typically taking place with respect to a subsurface formation. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.). Hydrocarbon management may include reservoir surveillance and/or geophysical optimization. For example, reservoir surveillance data may include, well production rates (how much water, oil, or gas is extracted over time), well injection rates (how much water or CO₂ is injected over time), well pressure history, and time-lapse geophysical data. As another example, geophysical optimization may include a variety of methods geared to find an optimum model (and/or a series of models which orbit the optimum model) that is consistent with observed/measured geophysical data and geologic experience, process, and/or observation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, “water injection rate” refers to the rate of water injected into the reservoir to pressurize and displace hydrocarbons to producing wells.

As used herein, “workover” refers to the repair or stimulation of an existing production well for the purpose of restoring, prolonging or enhancing the production of hydrocarbons.

If there is any conflict in the usages of a word or term in this specification and one or more patent or other documents that may be incorporated herein by reference, the definitions that are consistent with this specification should be adopted for the purposes of understanding this disclosure.

### Overview

As previously mentioned, Uncon OG production is increasingly a larger component of world OG production. However, when compared to conventional and deep-water OG production, Uncon OG production has different characteristics that make optimization more difficult. First, the production rate per well in Uncon OG production decays faster. For example, the decay may be from a few thousand barrels per day to a few hundreds barrel per day within a year. Second, well flow rates in Uncon production may change daily due to the dynamic adjustments of choke, emergency shut-in and artificial lift set point. Third, well count in a producing field of an Uncon OG production can increase significantly within a year. Finally, the total well count for production at scale is in the range of hundreds to thousands of wells.

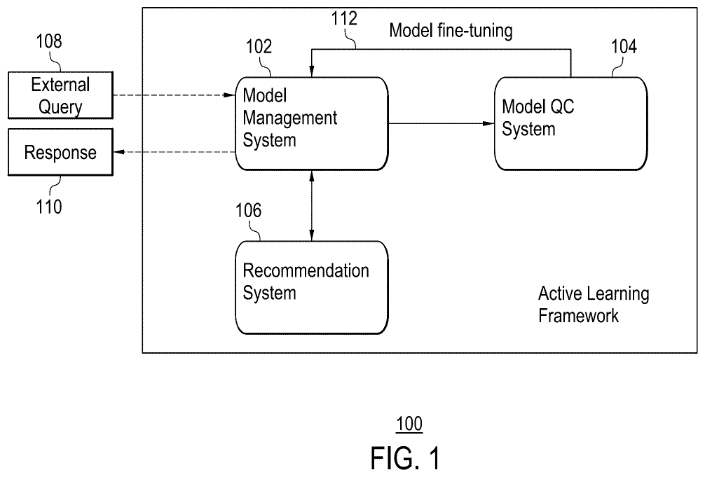

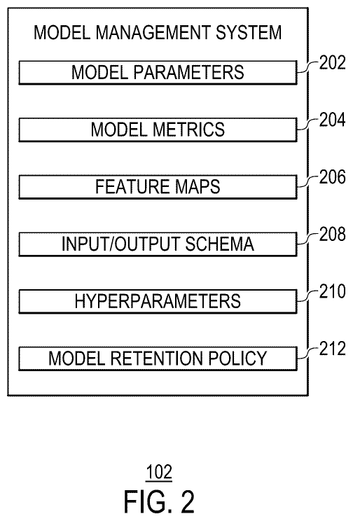

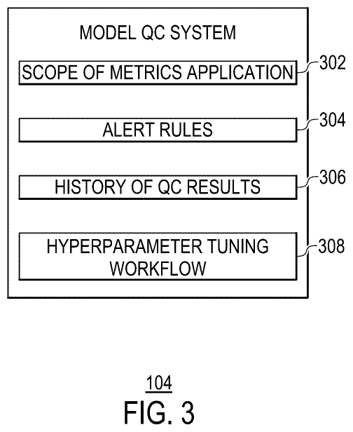

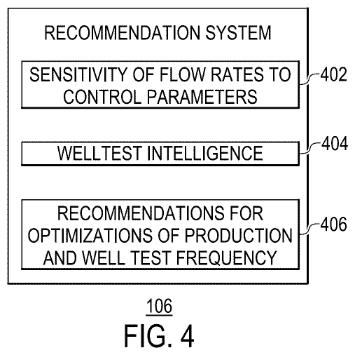

The present techniques provide an automated means of generating recommendations for improving production in a system of wells using an active learning framework. The active learning framework can be implemented by fine-tuning predictive machine learning models for a system of wells. In various embodiments, the active learning framework may include three components. In the first component, a model management system manages the machine learning (ML) models and provisions Application Programming Interfaces (APIs) to external queries. An example model management system is described with respect to FIG. 2. In the second component, a model quality control (QC) system controls the quality of the ML models against a set of metrics. An example QC system is described with respect to FIG. 3. In a third component, a recommendation system provides various specific recommendations to field operations. An example recommendation system is described with respect to FIG. 4. A system that implements an active learning framework combining these techniques to automatically generate optimization recommendations is described with respect to FIG. 1.

The present techniques may derive one or more benefits. First, the automated active learning framework enables the provision of various predictive and prescriptive solutions to production optimization at a higher frequency, up to real-time. Additionally, embodiments described herein account for the fast-changing characteristics of Uncon OG production. Second, the methodology provides an automated simplified means of efficiently maintaining model quality. Moreover, initial prototyped models have demonstrated that present techniques can be implemented using a number of different statistical and data analysis techniques and machine learning algorithms, including time-series machine learning techniques. Thus, any range of different statistical and data analysis techniques and machine learning algorithms can be used depending on the target prediction performance and robustness. Finally, new features are continuously integrated into the active learning framework described herein, and the workflows under the active learning framework are run automatically in production with minimal manual configurations.

### Exemplary System Implementing the Present Techniques

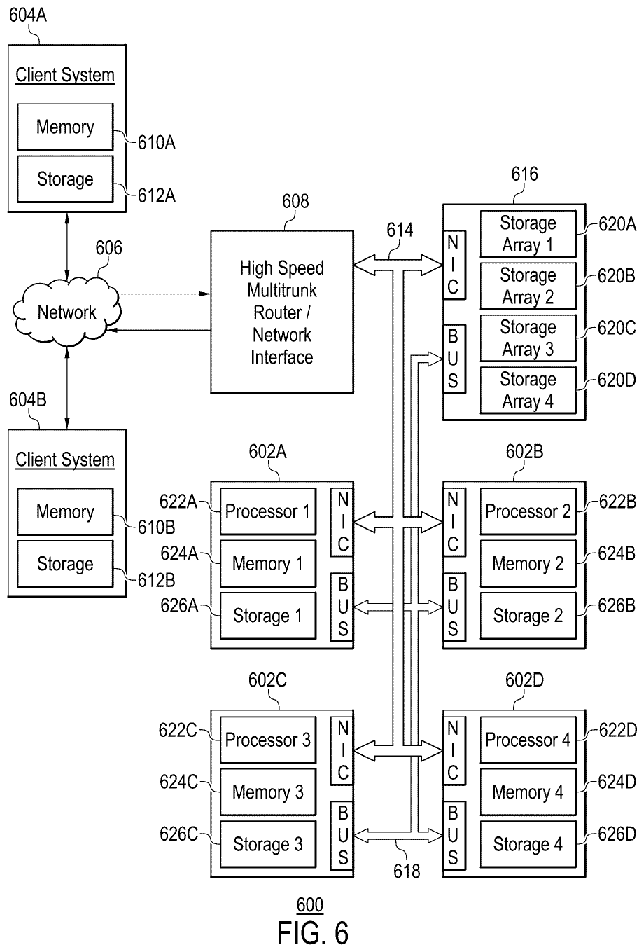

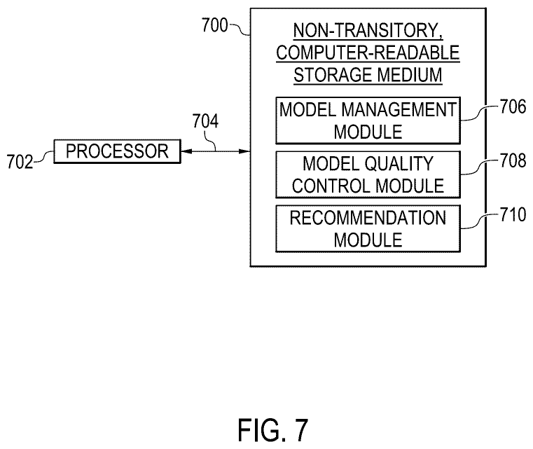

FIG. 1 is a schematic view of an exemplary active learning framework 100, in accordance with the present techniques. The exemplary active learning framework 100 includes a model management system 102, a model quality control (QC) system 104, and a recommendation system 106. In various embodiments, the active learning framework 100 is implemented using one or more processors, such as those in the cluster computing system 600 of FIG. 6, or the processor 702 of FIG. 7, described below.

The model management system 102 is shown receiving an external query 108 and sending a response 110. For example, the external query 108 may be received from an external computing device. In some embodiments, the model management system 102 provisions Application Programming Interfaces (API's) in the response 110 to the external queries 108. In various embodiments, the model management system 102 also manages a set of ML models. In some embodiments, the set of ML model are related. For example, each of the ML models in a set may be trained to predict a particular aspect of a system of wells. As one example, the model management system 102 can manage the ML models as described in greater detail with respect to FIG. 2. In various embodiments, the model management system 102 passes the ML models to the model QC system 104 to quality-control the ML models. For example, one or more of the ML models can be retrained by the model management system 102 in response to the model QC system 104 detecting that a prediction uncertainty of an ML model exceeds a set threshold.

The model QC system 104 quality-controls the ML models against a set of metrics. For example, the model QC system 104 can use the set of metrics to determine whether the performance of an ML model has improved or degraded after retraining on additional data. In various embodiments, the set of metrics includes a set of defining metrics with which ML models are compared against each other. In some embodiments, based on the metrics, one or more of the ML models are selected to use for generating recommendations. In various embodiments, the model QC system 104 is also responsible for feature and hyperparameter tuning of the training process for the ML models, as described in greater detail with respect to FIG. 3. For example, in some embodiments, the model QC system 104 tunes hyperparameters of a training process for a received ML models in response to detecting that a model prediction error of the received ML model exceeds a threshold. In various embodiments, the model QC system 104 then provisions the model fine-tuning 112 feedback to the model management system 102. The model management system 102 then fine-tunes the ML models by re-training the ML models on updated data in response to detecting that a model prediction error of a particular ML model exceeds a threshold. In various embodiments, the model QC system 104 then compares the performance of each fine-tuned model against the previous model via the set of metrics to determine whether the fine-tuned model performs better than the previous version of the model. In some embodiments, each pair of models may be tested by the model QC system 104 using updated well test data. Well test data may include real-time pressure and temperature during well tests, as well as oil density, and oil, water, and gas rates. In various examples, well test data may include controlled variables and measured variables. In various embodiments, controlled variables can include: well on test, operating pressure, and frequency of fluid removal from the oil and water leg (oil dump rate controlled by liquid level in the oil leg). Well test data also include measured variables, which can include: oil rates, water rates, and gas rates (typically reported in volumes), and oil leg density. As the oil leg is typically instrumented with a Coriolis meter (which provides mass rate and density), additional measurements may include the fluid density and the instrument drive gain. The measured density of the oil leg can provide an indication of water carryover in the oil leg which can be used, along with the dump behavior, to indicate sand buildup in the separator.

In various embodiments, one or more of the fine-tuned ML models are selected by the model management system 102 and passed to the recommendation system 106. The recommendation system 106 can then generate recommendations based on one or more of the tuned ML models. For example, in some embodiments, by monitoring the model predictions, the recommendation system 106 can also provide insights on health of wells. For example, in response to detecting that a well is significantly below planned production level, the recommendation system 106 can recommend switching to another artificial lift method. In some embodiments, the recommendations may be related to economics of the well operations. In some embodiments, the recommendations are generated based on feature importance seriatim of the fine-tuned ML model. For example, the feature importance seriatim may be generated from a set of feature maps, as shown in FIG. 2. The feature importance seriatim may be generated during training of a fine-tuned ML model. In some embodiments, generating the recommendation includes performing a sensitivity scan using the fine-tuned ML model. For example, each of the features may be varied to determine the sensitivity of the output to each of the features. Sensitivity of the output is measured after the fine-tuned model is trained. In general, both feature importance and feature sensitivity thus measure how model results vary when features are varied.

In various embodiments, hydrocarbons are then produced from the well based on the recommendations. For example, producing the hydrocarbons can include setting a choke set point for a well of the system of wells based on the recommendation. In some embodiments, producing the hydrocarbons includes setting a gas lift set point for a well of the system of wells based on the recommendation. In some embodiments, more frequent well tests are performed in the field operations based on a recommendation. For example, the recommendation system 106 can recommend more frequent well tests in response to detecting that a prediction uncertainty of the model exceeds a set threshold. In this example, the model QC system 104 can then instruct the model management system 102 to retrain one or more models on the updated data from the well tests via another model fine-tuning 112. For example, the updated data may include updated hyperparameters and/or an updated feature selection. The updated data is then used by model management system 102 to re-train the model on at least partially updated well test data. In this manner, the frequency of well testing and associated costs can be reduced without affecting model quality by directly adjusting the frequency of well testing based on a threshold quality of the ML models.

In some embodiments, the model QC system 104 or the recommendation system 106 can also be augmented with pre-processing or post-processing rules. For example, the pre-processing or post-processing rules can be used to filter out invalid input data and/or output data.

FIG. 2 is a block diagram of an exemplary model management system 102. The example model management system 102 of FIG. 2 includes a set of model parameters 202, a set of model metrics 204, a set of feature maps 206, an input/output schema 208, a set of hyperparameters 210, and a model retention policy 212. In various embodiments, the model management system 102 is implemented in the active learning framework 100 using one or more processors, such as those in the cluster computing system 600 of FIG. 6, or the processor 702 of FIG. 7.

In various embodiments, the model parameters 202 include a set of parameters that constitute each of the ML models. The model parameters 202 are internal values that are automatically learned by the ML model during the training process and directly influence the behavior and predictions of the ML model. For example, in neural networks, model parameters 202 are weights that are adjusted during training using one or more loss functions based on some set of predicted values and corresponding ground truth values. For example, the weights can be adjusted using stochastic gradient descent or any other suitable method. In linear regression models, model parameters 202 are the coefficients of variables. Similarly, in decision trees, the model parameters 202 may corresponding to split points.

In some embodiments, the model metrics 204 are used during training of the ML models to adjust the model parameters 202. As one example, the model metrics 204 include an absolute error metric. For example, the absolute error can be a mean absolute error metric. As another example, the model metrics 204 include coefficient of determination (R²). The coefficient of determination is the proportion of the variation in the dependent variable that is predictable from the independent variable(s). In various embodiments, the model metrics 204 are also used to selected trained models for use in generating recommendations.

The feature maps 206 are model features detected from input data using filters or kernels. For example, in the example of convolutional neural networks (CNNs), feature maps, also referred to as activation maps, capture features from an input data to aid the neural network in decision-making. In the example of CNNs, feature maps 206 enable the CNNs to process large datasets faster by discarding unwanted data and retaining important information in the form of features. For example, the original data may be discarded, and lower-level feature maps 206 can be further processed to generate additional features maps with higher level features at additional convolutional layers. In the context of predicting pressure or temperature for Uncon OG production, features may include temperatures and pressures, such as bottom hole pressure/temperature, flowline pressure, and wellhead pressure.

In various embodiments, the input/output schema 208 defines the structure of the data processed via the ML models. For example, the input/output schema 208 includes the format of the data, the range of potential inputs that can be handled, as well as the range of potential outputs that can be generated. Accordingly, the input/output schema 208 is predefined before any ML models are generated.

In various embodiments, the hyperparameters 210 are parameters that define details of the machine learning process, rather than the models themselves. Hyperparameters 210 are thus set before training, and often tuned to find a combination of hyperparameter values that leads to the best performance on unseen data. For example, hyperparameters 210 can be tuned by using a validation subset of training data and minimizing validation error. In various embodiments, the hyperparameters 210 include learning rate, batch size, mini-batch size, number of hidden layers and neurons in a neural network, number of clusters in a k-means clustering model, or choice of optimizer, among other learning process parameters. For example, in the model type of tree-bases, the hyperparameters 210 used may include learning rate, tree depth, number of leaves. In some embodiments, hyperparameters 210 can also include the number of features used for training.

In various embodiments, the model retention policy 212 includes rules defining how long ML models or categories of ML models are to be retained. For example, the retention policy 212 rules on what to keep may depend on appropriate historic models to keep in case a historical rerun is needed. As one example, appropriate historic models may be kept to use after an input data roll-back is fixed. ML models can be classified based on various factors, such as risk level, performance, regulatory requirements, among other factors. These different categories can then be retained for different periods based on factors such as how long the underlying data used to train the model is to be retained, the expected shelf life of the model's performance, the actual performance of the model, or legal requirements, among other potential factors. The model retention policy 212 thus provides a systematic approach to tracking and maintaining the models, reducing clutter and improving efficiency. Moreover, by deleting outdated models that do not perform as well as newer models, the model retention policy 212 can save storage space and computing resources.

FIG. 3 is a block diagram of an exemplary model quality control (QC) system 104. The example model QC system 104 of FIG. 3 includes a scope of metrics application 302, a set of alert rules 304, a history of QC results 306, and a hyperparameter tuning workflow 308. In various embodiments, the model QC system 104 is implemented in the active learning framework 100 using one or more processors, such as those in the cluster computing system 600 of FIG. 6, or the processor 702 of FIG. 7.

The scope of metrics application 302 specifies which batteries or specific wells the metrics are applied to. In some examples, wells with relatively higher oil production rates are weighted more so that hyperparameter tuning is weighted towards those wells. The scope of metrics application 302 thus enables the selection of the training data according to a specified methodology.

The set of alert rules 304 specifies various thresholds for alerts. In some embodiments, the alert rules 304 includes a model size threshold. For example, the model size threshold is used to generate alerts in response to detecting that an ML model has exceeded a set size. In some embodiments, the alert rules 304 includes an error threshold. For example, the error threshold can be a prediction error threshold that is used to generate an alert in response to detecting that an ML model is predicting with an error that exceeds the threshold. As one example, the alert rules 304 may include the generation of an alert in response to detecting that a prediction of a flow rate has become negative or unreasonably large.

The history of QC results 306 includes a history of each metric that provides a statistical view of the model quality of each of the ML models. For example, in some embodiments, the statistical view includes mean absolute percent error, R² coefficient, among other statistical measures. For example, other statistical methods include root mean squared or sum of squared residuals. In various examples, these QC parameters are preserved in the history of QC results 306 for each time the model is trained, thus preserving a history of model goodness.

The hyperparameter tuning workflow 308 is a process of tuning the hyperparameters for a particular ML model. In various embodiments, the hyperparameter tuning workflow 308 is triggered regularly or based on a threshold to tune down the model prediction error for each ML model. In various embodiments, the hyperparameter tuning workflow 308 includes fixing an input set of training data and using different hyperparameters to obtain different ML models and then comparing the quality of outputs of the different ML models using the metrics in order to select a set of hyperparameters for training the ML models. For example, the hyperparameters workflow can increase the fidelity of an ML model by increasing the number of hyperparameters and/or the type of hyperparameters. In some embodiments, for a given training dataset, the relative importance or influence of each of the hyperparameters is measured and a subset of most influential hyperparameters selected for training the ML models on the set of training data. As one example of a hyperparameter tuning workflow 308, while oil, water, and gas rates predicted by the model exceed a threshold error rate as compared to well test (WT) measurements, hyperparameter retuning is initiated. Test data is selected to be representative of the existing conditions (with a focus on recent or highly correlated behavior), and a parameter estimation is initiated. QC and alerts are identified, and if the model passes these checks, then the new model is preserved in the history of QC results 306.

FIG. 4 is a schematic view of an exemplary block diagram of an exemplary recommendation system 106. The example recommendation system 106 of FIG. 4 includes a sensitivity of flow rates to control parameters unit 402, and a welltest intelligence unit 404. In various embodiments, the recommendation system 106 is implemented in the active learning framework 100 using one or more processors, such as those in the cluster computing system 600 of FIG. 6, or the processor 702 of FIG. 7.

The sensitivity of flow rates to control parameters unit 402 provides various recommendations to field operations. For example, choke and gas lift set points can be obtained by feature importance seriatim or performing a sensitivity scan using the ML models. The resulting recommendation can guide the field operation for production optimization. For example, in the context of virtual flow meters, the sensitivity of the flow rate to changes in the choke or gas lift may be tested, and recommendations generated in order of sensitivity to the flow rate. Thus, the flow rate can be more efficiently controlled by changing parameters with a higher sensitivity.

The welltest intelligence unit 404 generates insights for welltest frequency based on uncertainty level of predictions. In various embodiments, when the model prediction uncertainty exceeds a set threshold, the welltest intelligence unit 404 can recommend more frequent well tests in field operations. For example, well tests may involve rerouting production to a separator to accurately measure how much water, oil, and gas is actually being produced. However, such rerouting may be both time consuming and may also reduce the production rate temporarily before the production is rerouted back to the normal separator and production equipment. Thus, well testing can be reduced in frequency in order to increase overall production. However, reduction in well testing results in less accurate knowledge of how much a particular well is producing. Thus, well testing frequency can be based on uncertainty of prediction in the ML models and well testing thus performed in response to detecting that an uncertainty of an ML model prediction exceeds a threshold. The ML models are then retrained on the updated well test information to decrease the uncertainty of the predictions. In various embodiments, applying this uncertainty detection of models to multiple wells in a system of wells for a given time may result in an optimal well test frequency period for the system of wells. The welltest intelligence unit 404 can thus identify ideal times for performing well tests for particular wells in the system of wells.

The recommendations for optimizations and well test frequency unit 406 is responsible for the generation of recommendations to modify operation conditions to improve oil production. In various examples, such recommendations may include artificial lift (AL) changes, choke changes, field maintenance, instrument calibration requests, etc.

### Exemplary Hydrocarbon Production Techniques

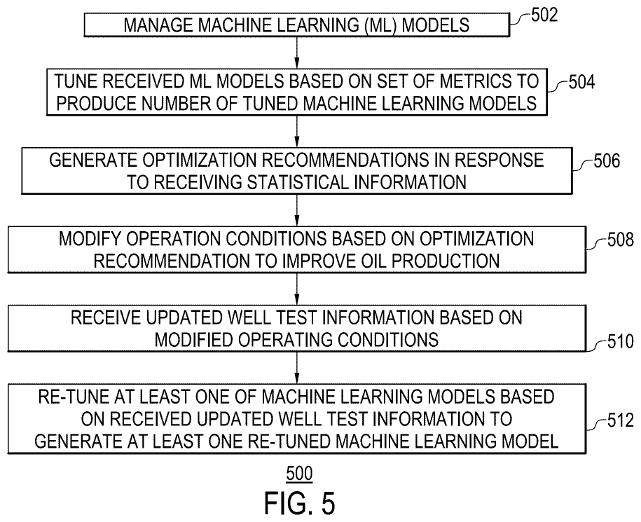

FIG. 5 is a process flow diagram of an exemplary method 500 for guiding hydrocarbon production using operating conditions modified based on optimization recommendations, in accordance with this disclosure. The exemplary method starts at block 502, where machine learning (ML) models are managed. For example, the ML models can be managed via a model management system. In various examples, each of the ML models may be trained for a different phase. For example, all wells use the same model for one phase rate. Thus, in various embodiments, the number of models is not proportional to the number of wells. For example, the machine learning models may be neural networks trained on historical well test data. In various embodiments, the well test data may include real-time pressure and temperature during well tests, as well as oil density, and oil, water, and gas rates. In some embodiments, the well test data also include various controlled variables and measured variables, as discussed above. For example, controlled variables can include: well on test, operating pressure, and frequency of fluid removal from the oil and water leg. In various embodiments, measured variables can include: oil rates, water rates, and gas rates, and oil leg density.

At block 504, the received ML models are tuned based on a set of metrics to produce a number of tuned machine learning models. For example, parameters of a received ML model are modified based on updated well test information to produce a tuned machine learning model.

At block 506, optimization recommendations are generated in response to receiving statistical information. In various embodiments, the tuned machine learning model uses operational conditions per well to give rate predictions. The statistical information is calculated based on the rate predictions. For example, the statistical information can include various measurements, such as mean absolute percent error, R² coefficient, among other statistical measures. In some examples, other statistical information can include root mean squared or sum of squared residuals. In some embodiments, the optimization recommendations are generated based on feature importance seriatim of the fine-tuned model. For example, the feature importance seriatim are the importance of input features to the model. In various embodiments, most of these features are operational conditions, such as flow line and well head pressure. In various embodiments, the optimization recommendations can include performing more frequent well tests in field operations. For example, recommending more frequent well tests in response to detecting that a prediction uncertainty of the model exceeds a set threshold. In some embodiments, the optimization recommendations are generated performing a sensitivity scan using the fine-tuned model. For example, model prediction results can be inspected using the sensitivity scan by varying one or more features and analyzing resulting changes in output performance. In various embodiments, a list of control parameters and the associated sensitivity of the flow rate can be generated using the tuned models. In some embodiments, the optimization recommendations can include recommendations to modify operation conditions to improve oil production. In various examples, such recommendations may include AL changes, choke changes, field maintenance, instrument calibration requests, etc.

At block 508, operation conditions are modified based on the optimization recommendations to improve oil production. In various embodiments, a control parameter to be modified is selected based on a sensitivity of a flow rate to the control parameter identified in the generated optimization recommendations. In some embodiments, a choke set point for a well of the system of wells is updated based on the optimization recommendations. In some embodiments, a gas lift set point for a well of the system of wells is updated based on the optimization recommendations.

At block 510, updated well test information based on the modified operating conditions is received. In various embodiments, a time that the updated well test information is received is determined based on an uncertainty of at least one of the tuned machine learning models. For example, an updated well test may be performed in response to detecting that an uncertainty of at least one of the tuned machine learning models exceeds a threshold, and the resulting updated well test information received.

At block 512, the at least one of the machine learning models is re-tuned based on the received updated well test information to generate at least one re-tuned machine learning model. In some embodiments, hyperparameters of at least one of the machine learning models are re-tuned. For example, the ML model may be trained again on the updated well test data using the re-tuned hyperparameters. In various embodiments, any number of model parameters are modified in the ML model during training. In various embodiments, the machine learning models are re-tuned in response to detecting that a model prediction error of the received ML model exceeds a threshold. In some embodiments, the machine learning models are re-tuned in response to detecting a change in the set of metrics.

Those skilled in the art will appreciate that the exemplary method 500 of FIG. 5 is susceptible to modification without altering the technical effect provided by this disclosure. In practice, the exact manner in which the method 500 is implemented will depend, at least in part, on the details of the specific implementation. For example, in some embodiments, some of the blocks shown in FIG. 5 may be altered or omitted from the method 500 and/or new blocks may be added to the method 500. For example, in some embodiments, the method 500 may further include additional re-tuning of hyperparameters or re-training ML models on additionally received well test data. Moreover, in various embodiments, the order of the blocks may also be modified. For example, in some embodiments, block 510 may be executed before 508, especially if no modifications are needed before new data is acquired.

### Exemplary Cluster Computing System for Implementing Present Techniques

FIG. 6 is a block diagram of an exemplary cluster computing system 600 that may be utilized to implement the present techniques. The exemplary cluster computing system 600 shown in FIG. 6 has four computing units 602A, 602B, 602C, and 602D, each of which may perform calculations for a portion of the present techniques. However, one of ordinary skill in the art will recognize that the cluster computing system 600 is not limited to this configuration, as any number of computing configurations may be selected. For example, a smaller analysis may be run on a single computing unit, such as a workstation, while a large calculation may be run on a cluster computing system 600 having tens, hundreds, thousands, or even more computing units.

The cluster computing system 600 may be accessed from any number of client systems 604A and 604B over a network 606, for example, through a high-speed network interface 608. The computing units 602A to 602D may also function as client systems, providing both local computing support and access to the wider cluster computing system 600.

The network 606 may include a local area network (LAN), a wide area network (WAN), the Internet, or any combinations thereof. Each client system 604A and 604B may include one or more non-transitory, computer-readable storage media for storing the operating code and program instructions that are used to implement the present techniques. For example, each client system 604A and 604B may include a memory device 610A and 610B, which may include random access memory (RAM), read only memory (ROM), and the like. Each client system 604A and 604B may also include a storage device 612A and 612B, which may include any number of hard drives, optical drives, flash drives, or the like.

The high-speed network interface 608 may be coupled to one or more buses in the cluster computing system 600, such as a communications bus 614. The communication bus 614 may be used to communicate instructions and data from the high-speed network interface 608 to a cluster storage system 616 and to each of the computing units 602A to 602D in the cluster computing system 600. The communications bus 614 may also be used for communications among the computing units 602A to 602D and the cluster storage system 616. In addition to the communications bus 614, a high-speed bus 618 can be present to increase the communications rate between the computing units 602A to 602D and/or the cluster storage system 616.

The cluster storage system 616 can have one or more non-transitory, computer-readable storage media, such as storage arrays 620A, 620B, 620C and 620D for the storage of models, data (including core data relating to one or more wells), visual representations, results (such as graphs, charts, and the like used to convey results obtained using the present techniques), code, and other information concerning the implementation of the present techniques. The storage arrays 620A to 620D may include any combinations of hard drives, optical drives, flash drives, or the like.

Each computing unit 602A to 602D can have a processor 622A, 622B, 622C and 622D and associated local non-transitory, computer-readable storage media, such as a memory device 624A, 624B, 624C and 624D and a storage device 626A, 626B, 626C and 626D. Each processor 622A to 622D may be a multiple core unit, such as a multiple core central processing unit (CPU) or a graphics processing unit (GPU). Each memory device 624A to 624D may include ROM and/or RAM used to store program instructions for directing the corresponding processor 622A to 622D to implement the present techniques. Each storage device 626A to 626D may include one or more hard drives, optical drives, flash drives, or the like. In addition, each storage device 626A to 626D may be used to provide storage for models, intermediate results, data, images, or code associated with operations, including code used to implement the present techniques.

The present techniques are not limited to the architecture or unit configuration illustrated in FIG. 6. For example, any suitable processor-based device may be utilized for implementing all or a portion of embodiments of the present techniques, including without limitation personal computers, laptop computers, computer workstations, mobile devices, and multi-processor servers or workstations with (or without) shared memory. Moreover, embodiments may be implemented on application specific integrated circuits (ASICs), or very-large-scale integrated (VLSI) circuits. In fact, persons of ordinary skill in the art may utilize any number of suitable structures capable of executing logical operations according to embodiments described herein.

FIG. 7 is a block diagram of an exemplary non-transitory, computer-readable storage medium 700 that may be used for the storage of data and modules of program instructions for implementing the present techniques. The non-transitory, computer-readable storage medium 700 may include a memory device, a hard disk, and/or any number of other devices, as described herein. A processor 702 may access the non-transitory, computer-readable storage medium 700 over a bus or network 704. While the non-transitory, computer-readable storage medium 700 may include any number of modules (and sub-modules) for implementing the present techniques, in some embodiments, the non-transitory, computer-readable storage medium 700 includes a model management module 706. More specifically, the model management module 706 may direct the processor 702 to manage a number of machine learning models. In various embodiments, the model management module 706 includes code to accept and respond to external queries. For example, in some embodiments, the external query includes current data, and, in response to receiving the external query, the model management module 706 includes code to run a machine learning model with the current data to generate a prediction result including statistical information. For example, the statistical information may include a statistical average. In some embodiments, the model management module 706 may direct the processor 702 to store the machine learning model, model parameters of the machine learning model, model artifacts of the machine learning model, and the prediction result in a database. In various embodiments, the model management module 706 may direct the processor 702 to send machine learning models or artifacts and parameters of the machine learning models to a model quality control module 708. In some embodiments, the artifacts and parameters are sent simultaneously. In some embodiment, the artifacts and parameters are sent sequentially. In some embodiments, the artifacts and parameters are sent on a time basis. For example, the artifacts and parameters may be sent after a threshold amount of time has been exceeded. In some embodiments, the artifacts and parameters of the machine learning models are sent in response to detecting that a metric exceeds a threshold. In some embodiments, the model management module 706 may direct the processor 702 to send statistical information to a recommendation module 710. For example, in some embodiments, the model management module 706 may direct the processor 702 to send the model prediction result including uncertainty bands to the recommendation module 710 in response to detecting that a threshold is exceeded.

Furthermore, in some embodiments, the non-transitory, computer-readable storage medium 700 includes a model quality control module 708 that can cause the processor to receive a machine learning model from the recommendation module 706 and to tune the machine learning model based on a set of metrics to produce a tuned machine learning model, wherein the second sub-system is to send a model component of the tuned machine learning model to the first sub-system. In some embodiments, each of any number of machine learning models are tuned individually. For example, the tuning of each machine learning model continues until an acceptance criteria threshold is exceeded.

In addition, in some embodiments, the non-transitory, computer-readable storage medium 700 includes a recommendation module 710 for generating optimization recommendations. In some embodiments, the model management module 710 may direct the processor 702 to generate an optimization recommendation in response to receiving statistical information from the first sub-system. For example, the optimization recommendation is used to modify operation conditions to improve oil production. In some embodiments, modifying operations includes adjusting a control parameter of a system of wells. For example, the control parameter can be adjusted by updating a choke set point for a well of the system of wells based on the optimization recommendation. In some examples, the control parameter is adjusted by updating a gas lift set point for a well of the system of wells based on the optimization recommendation. In some embodiments, the the optimization recommendation includes performing more frequent well tests in field operations based on the recommendation.

In this manner, the techniques described herein provide a practical application that directly improves the efficiency and accuracy of modelling pressure and temperature in a system of wells, and thus enables inferred virtual rates to be generated for a variety of scenarios. The techniques thus further enable optimization of production rates for the overall system by generating recommended manipulative variables, such as gas-lift rate, electrical submersible pump (ESP) current, choke, workover, and priority.

Although embodiments herein are described with respect to the unconventional oil extraction, one with skilled in the art will readily recognize that the techniques described herein are also suitable for application in other areas. For example, such applications may include carbon storage applications, among other applications within hydrocarbon management. It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

### Temperature and Pressure Prediction in System of Wells Example

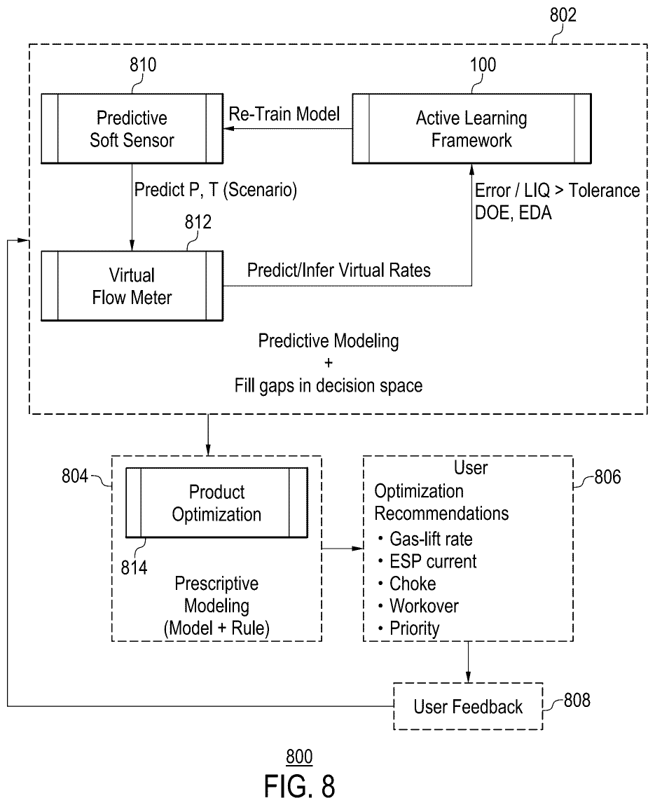

FIG. 8 is a schematic view of an exemplary system 800 for predicting changes in temperature and pressure in a system of wells using an active learning framework, in accordance with the present techniques. The system 800 includes a predictive modeling unit 802 communicatively coupled to a prescriptive modeling unit 804. The prescriptive modeling unit 804 includes a product optimization module 814. The system 800 also includes a user device 806 communicatively coupled to the predictive modeling unit 802 and the prescriptive modeling unit 804. A user device 806 receives optimization recommendations from the prescriptive modeling unit 804. For example, the optimization recommendations can include recommended optimal gas-lift rates, ESP currents, choke points, workovers, and priorities. The user device 806 is shown transmitting received user feedback 808 to the predictive modeling unit 802. The predictive modeling unit 802 further includes a predictive soft sensor 810 coupled to a virtual flow meter (VFM) 812. The predictive modeling unit 802 also further includes an active learning framework 100 communicatively coupled to the predictive soft sensor 810 and the virtual flow meter 812.

The system 800 can predict the flow rates of a given well in a system of wells with uncertainty and also perform various optimization actions. For example, the flow rates may include oil, water, and gas flow rates. In some embodiments, the workflow of the system 800 includes soft sensing, inferred production, automated model management and active learning, and the use of a user feedback loop. In general, well test data and other sensor data from the system of wells may be validated and quality analyzed (QA) and quality controlled (QC) as descriptive analytics. For example, a separator can be used to measure rates provided in the dynamically sensed data. Such a separator may be validated to ensure that it is providing accurate representative rates. In some embodiments, the quality of the data may be assured based on if a tag exists or not. For example, a basic sanity check may be performed to discard any values that are not possible. As one example of such a sanity check, negative values may be discarded where an absolute value scale is being used. For example, negative flow rates or negative pressure may be filtered out. Moreover, a dynamic form of quality checking may also be used for dynamically sensed data. For example, values may be compared with previously received values to determine whether changes in the values are physically realistic. In this regard, the first derivative or second derivative of the input values over time may be used to compare against a threshold rate of change and discard any values exceeding such threshold. In this manner, values indicating instantaneous step changes may be discarded, as well as series of values indicating no changes where no change is impossible. For example, such values may be caused by technical issues in the sensors rather than changes in operating conditions. Such validation and quality control may provide a solid foundation enabling the surveillance of assets.

In various embodiments, the observations and quality control are based on intuition from physics. The system 800 may thus be described as physics-assisted. For example, the downhole pressure may be checked to be within a range of pounds per square inch (PSI) or Pascal (Pa) values. As another example, fluids may be checked to be flowing in the direction of decreasing pressure. As yet another example, reservoir temperatures cannot be 250 Fahrenheit, or 121.11 degrees Celsius.

In various embodiments, with the application of soft sensing, inferred production and automated model management and Active Learning, a predictive analysis is performed through series of supervised machine learning models and statistical techniques. In some embodiments, the predictive analysis of system 800 is further enhanced by prescriptive analytics of scenario explorations, optimization while integrating user feedback, production operation best practices, and uncertainty quantification.

In various embodiments, the predictive soft sensor 810 obtains the best prediction of changes in pressure and temperature of a given well due to a change in operating conditions. For example, such changes in operating conditions may include choke changes, artificial lift parameter changes, or workovers, among other operating condition changes. In some embodiments, the predictive soft sensor 810 is a combination of unsupervised event detection and segmentation (change in manipulated variables), response surface modeling and multivariate machine learning models using high frequency well measurements and well static data. In particular, due to changing reservoir conditions, choke change versus pressure changes relationship is modeled as a function of time. The soft sensing algorithm of the predictive soft sensor 810 detects the events, segments the data and performs the model training on segmented data instead of building a model from hypothetical assumptions or from laboratory experiments. Thus, detected special events such as a reservoir build-up will be identified from a segment and become a part of training dataset.

In various examples, an unsupervised event detection may be performed using time-series analysis and signal processing on static data and dynamic data. For example, various well sensors may provide high frequency downhole, tubing head, and flow line, pressures and temperature data. Long term pressure data may provide quantitative information about the well and reservoir behavior for different operating scenarios. Examples of detected events may include reservoir pressure build-up or draw-down, ESD, slugging events, among other types of events.

In various embodiments, the predictive soft sensor 810 also performs segmentation. The segmentation performed by the predictive soft sensor 810 may be performed using any suitable segmentation algorithm. For example, the segmentation algorithm used may be a change point detection algorithm.

In some embodiments, the predictive soft sensor 810 uses machine learning methods to learn from the set of well sensor data and predict changes in pressures and temperatures for different operating scenarios. For example, the predictive soft sensor 810 may include multivariate machine learning models that are trained on the well sensor data. In various embodiments, the training of the multivariate machine learning models may include the use of regression and Bayesian methods. In various embodiments, the predictive soft sensor 810 extracts pressure and temperature as a function of the manipulative variables. For example, the predictive soft sensor 810 can thus extract the pressure/temperature relationship versus manipulative variables such as choke, artificial lift and workovers directly from the field measurements. In various examples, the predictive soft sensor 810 can also quantify uncertainty of the algorithm output in terms of changes in pressure and temperature and provide potential errors and uncertainties in the used features, such as choke changes, artificial lift parameter changes or workovers.

In various embodiments, the Virtual Flow Meter (VFM) 812 includes a model that predicts three-phase rates from available sensor measurements such as downhole, tubing head, flowline pressures and temperatures. For example, the three-phase rates may include gas, oil, and water rates. In some embodiments, a multivariate supervised machine learning approach is used to train a predictive model to learn statistical relationship between historical well test data, well static data, completion data, reservoir parameters and high frequency well measurements. In some embodiments, methods such as Bayesian and/or quantile regression are used to quantify the uncertainty of the predictions.

In various embodiments, the trained and tuned models of the predictive soft sensor 810 and Virtual Flow Meter (VFM) 812 are sustained and maintained utilizing a Machine Learning Operations (MLOps) framework. MLOps provides a framework for managing a machine learning lifecycle effectively and efficiently. In some embodiments, the MLOps framework is part of the model management and/or active learning unit 100. For example, models can be retrained on fixed frequency to take into account new well tests or trigger by error threshold. Revisions of models and key parameters/metrics are then stored. Prediction (also referred to as inference) can then performed based on a most recent revision of the model. In some examples, older models can be retrieved to rerun on historical data for reference. The MLOps framework can thus be used to provide a robust and automated way of re-training, monitoring and assessing model performance through uncertainty and error. For example, when a model prediction performance is below desired threshold, hyperparameter tuning and Active Learning are used to improve model qualities of the predictive soft sensor 810 and VFM 812.

In various embodiments, the active learning framework 100 is used to augment a data-driven approach. In various embodiments, the active learning framework 100 uses an automated field experiment workflow to train machine learning models based on design of experiment (DOE) and explanatory data analysis (EDA). If the uncertainty of the prediction or error exceeds the tolerance, then the active learning framework 100 re-tunes the training process and retrains one of more of the machine learning models. As one example, active learning may be performed during an extended well test duration. For example, the active learning model may utilize a portion of time to train the model by introducing data from updated well testing that the model has never trained on before, as described above.

In various embodiments, the user device 806 may include an interactive tool with an automated feedback loop. The system 800 can then receive user feedback 808 to use as input to the machine learning model to capture high quality labels to the machine learning model as well as a source of monitoring model performance to efficiently maintain model quality. For example, the high-quality labels may be captured by manual labeling from production engineers and thus closer to the observation of production engineers than automatically generated labels.

In some embodiments, hyperparameter tuning is also used to enhance accuracy and/or performance of prediction. For example, hyperparameter tuning may be used to optimize hyperparameters to enhance predictive performance of machine learning model. As one example of hyperparameter tuning, a user may use hyperparameter tuning to train a model for gas rate for more stringent error criteria compared to a well test.

In some embodiments, feature engineering can be triggered based on the user feedback 808. For example, feature engineering may be used to drive right the form of input in terms of quantity and quality to a machine learning model and thus enhance performance. As one example of feature engineering, ESP related features such as ESP current may be added to train an oil flow rate model. Thus, in various embodiments, the system 800 supports not only retrospective analysis, but also forward planning.

The active learning framework 100 can actively manage a number of ML models for the system of wells. For example, in some embodiments, the active learning framework 100 manages a number of models for each well in the system of wells, including predictive soft sensor models and virtual flow meter models. In various embodiments, the active learning framework 100 also provides version tracking of the models, as well as tracking which versions of the models are currently being used and when the models were last updated. In this manner, the active learning framework 100 enables a fully automated system. The active learning framework 100 thus facilitates and streamlines various tedious tasks by a) automating model hyperparameter tuning; b) streamlining tasks as model storage and executing model predictions; c) providing more human actionable insights from the recommendation system instead of obtaining those insights from mounting data analysis work.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. In addition, all numerical values within the detailed description herein are modified by “about” the indicated value, and take into account experimental errors and variations that would be expected by a person having ordinary skill in the art. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. An apparatus, comprising:
a first sub-system to manage a plurality of machine learning models, wherein the first sub-system is to accept and respond to an external query;
a second sub-system to receive a machine learning model from the first sub-system and to tune the machine learning model based on a set of metrics to produce a tuned machine learning model, wherein the second sub-system is to send a model component of the tuned machine learning model to the first sub-system; and
a third sub-system to generate an optimization recommendation in response to receiving statistical information from the first sub-system, wherein the optimization recommendation is used to modify operation conditions to improve oil production.

2. The apparatus of claim 1, wherein modifying operations comprises adjusting a control parameter of a system of wells.

3. The apparatus of claim 2, wherein the control parameter is adjusted by updating a choke set point for a well of the system of wells based on the optimization recommendation.

4. The apparatus of claim 2, wherein the control parameter is adjusted by updating a gas lift set point for a well of the system of wells based on the optimization recommendation.

5. The apparatus of claim 1, wherein the optimization recommendation comprises performing more frequent or less frequent well tests in field operations based on the recommendation.

6. The apparatus of claim 1, wherein the external query comprises current data and, in response to receiving the external query, the first-subsystem is to run the machine learning model with the current data to generate a prediction result comprising the statistical information.

7. The apparatus of claim 6, wherein the first-subsystem is to store the machine learning model, model parameters of the machine learning model, model artifacts of the machine learning model, and the prediction result in a database.

8. The apparatus of claim 6, wherein the first sub-system is to send the model prediction result comprising uncertainty bands to the third sub-system in response to detecting that a threshold is exceeded.

9. The apparatus of claim 6, wherein the statistical information comprises a statistical average.

10. The apparatus of claim 1, wherein first sub-system sends artifacts and parameters of the plurality of machine learning models to the second sub-system.

11. The apparatus of claim 10, wherein the artifacts and parameters of the plurality of machine learning models are sent simultaneously.

12. The apparatus of claim 10, wherein the artifacts and parameters of the plurality of machine learning models are sent sequentially.

13. The apparatus of claim 10, wherein the artifacts and parameters of the plurality of machine learning models are sent on a time basis.

14. The apparatus of claim 10, wherein the artifacts and parameters of the plurality of machine learning models are sent in response to detecting that a metric exceeds a threshold.

15. The apparatus of claim 1, wherein each of the plurality of machine learning models are tuned individually.

16. The apparatus of claim 1, wherein the tuning of the machine learning model continues until an acceptance criteria threshold is exceeded.

17. A method for managing a system of wells, wherein the method is executed via a processor of a computing system, and wherein the method comprises:
managing a plurality of machine learning models;
tuning a machine learning model of the plurality of machine learning models based on a set of metrics to produce a tuned machine learning model;
generating an optimization recommendation in response to receiving statistical information; and
modifying an operation condition based on the optimization recommendation to improve oil production.

18. The method of claim 17, comprising:
receiving updated well test information based on the modified operating condition; and
re-tuning at least one of the machine learning models based on the received updated well test information to generate at least one re-tuned machine learning model.

19. The method of claim 18, wherein a time that the updated well test information is received is determined based on an uncertainty of at least one of the tuned machine learning models.

20. The method of claim 18, wherein re-tuning the at least one of the machine learning models comprises re-tuning hyperparameters of the at least one of the machine learning models.

21. The method of claim 18, wherein re-tuning the at least one of the machine learning models comprises modifying a parameter of the at least one of the machine learning models based on updated well test information.

22. The method of claim 17, wherein modifying the operation condition comprises updating a choke set point for a well of the system of wells based on the recommendation.

23. The method of claim 1, wherein modifying the operation condition comprises updating a gas lift set point for a well of the system of wells based on the recommendation.
